(19) United States
(12) Patent Application Publication
(10) Pub. No.: US 2016/0203655 A1
(43) Pub. Date: Jul. 14, 2016

(54) Multiple-Mode Data Acquisition System

(71) Applicant: CONTROL-TEC, LLC, Allen Park, MI (US)

(72) Inventors: William Leisenring, Tecumseh, MI (US); Naga Puttagunta, Northville, MI (US); Nathan Nantais, Windsor (CA)

(21) Appl. No.: 15/073,801

(22) Filed: Mar. 18, 2016

Related U.S. Application Data
(63) Continuation-in-part of application No. 13/352,076, filed on Jan. 17, 2012.
Application No. 13/352,076 is a continuation-in-part of application No. 13/134,660, filed on Jun. 14, 2011.
(60) Provisional application No. 61/513,933, filed on Aug. 1, 2011.
(60) Provisional application No. 61/461,538, filed on Jan. 18, 2011.

(51) Int. Cl. G07C 5/08

(52) U.S. Cl. CPC G07C 5/085

(57) ABSTRACT

A system for recording data from one or more electronic control units in one or more vehicles includes a data-recorder and a memory. The data-recorder is suitable for communication with an electronic control unit of a vehicle. The memory is in communication with the data-recorder. The memory is used to store configurations of vehicles. The configurations are used to configure the data-recorder to communicate with the vehicle. The memory is also used to store additional code used to configure data acquisition (DAQ) settings of the data-recorder to capture data from the vehicle at a first data-rate when a first trigger-signal transitions to a first state, and capture data from the vehicle at a second data-rate when a second trigger-signal transitions to a second state.

### CROSS-REFERENCE TO RELATED APPLICATIONS

This application is a continuation-in-part application and claims the benefit of U.S. patent application Ser. No. 13/352,076, entitled MULTIPLE-MODE DATA ACQUISITION SYSTEM, and filed on Jan. 17, 2012, which claims the benefit of U.S. patent application Ser. No. 13/134,660 filed on Jun. 14, 2011, which claims the benefit under 35 U.S.C. §119(e) of U.S. Provisional Patent Application No. 61/461,538 filed on Jan. 18, 2011 and U.S. Provisional Patent Application No. 61/513,933 filed on Aug. 1, 2011, the entire disclosure of which is hereby incorporated herein by reference.

### REFERENCE TO COMPACT DISCS FILED WITH PARENT APPLICATION

Duplicate compact discs (CD-R's) were filed with parent application Ser. No. 13/134,660 as a computer program listing appendix. Each compact disc contains the following files: “seldloggerCode” (24 KB, created Jan. 14, 2011) and “uploadDataCode” (50 KB, created Jan. 14, 2011). The material on the compact discs is incorporated herein by reference.

### COPYRIGHT NOTICE

A portion of the disclosure of this patent application (including the files contained on the compact discs) contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD OF INVENTION

This disclosure generally relates to an electronic control unit data recorder, such as vehicle data recorder.

### BACKGROUND OF INVENTION

A vehicle data recorder is a recording device which is present in a vehicle and which receives information from various electronic control units which are present in the vehicle. Each of the electronic control units controls one or more of the electrical systems or subsystems in the vehicle. Examples of some of the electronic control units which may be present in a vehicle include, but are not limited to, an airbag control unit, an engine control unit, a seat control unit, a speed control unit, and a transmission control unit. The vehicle data recorder receives information from the various electronic control units, and stores the information in memory and/or transmits the information wirelessly to a remote location. This information can be used for various purposes, for example to assess the function and performance of a pre-production or post-production vehicle, or to manage a fleet of vehicles.

A typical vehicle data recorder that is sufficiently intelligent to receive proprietary information from a vehicle is configured to only work with a specific vehicle configuration, such as a specific make and model of vehicle which has a certain engine and transmission, certain emission systems, as well as certain electronic control unit hardware/software configurations. Specifically, the vehicle data recorder has a configuration stored therein which dictates how the vehicle data recorder collects and processes data received from the electronic control units. The configuration which is stored in the vehicle data recorder is vehicle-specific. Therefore, to manage a fleet of vehicles, where the fleet includes vehicles of various configurations such as various makes and models of vehicles, one must employ a plurality of different vehicle data recorders.

### SUMMARY OF THE INVENTION

Described herein is an electronic control unit data recorder which is automated and efficient. Specifically, an embodiment of the present invention provides an electronic control unit data recorder, such as a vehicle data recorder, which is configured to provide multiple data acquisition tools in a single piece of hardware by having data acquisition software that is capable of acquiring data in different modes.

In accordance with one embodiment, a system for recording data from one or more electronic control units in one or more vehicles is provided. The system includes a data-recorder and a memory. The data-recorder is suitable for communication with an electronic control unit of a vehicle. The memory is in communication with the data-recorder. The memory is used to store configurations of vehicles. The configurations are used to configure the data-recorder to communicate with the vehicle. The memory is also used to store additional code used to configure data acquisition (DAQ) settings of the data-recorder to capture data from the vehicle at a first data-rate when a first trigger-signal transitions to a first state, and capture data from the vehicle at a second data-rate when a second trigger-signal transitions to a second state.

In another embodiment, the data-recorder captures data simultaneously at the first data-rate and the second data-rate when the second trigger-signal transitions to the second state.

In yet another embodiment, the data-recorder determines an on-board synthetic-data parameter based on sampled-data, and the first trigger-signal is based on the on-board synthetic-data parameter.

In another embodiment, the second trigger-signal occurs a time-interval after the first trigger-signal.

In yet another embodiment, the data-recorder determines statistical-data based on sampled-data, said statistical-data characterized as one of a minimum, a maximum, an average, a standard deviation, a variance, a signal-to-noise ratio, and a frequency, and the first trigger-signal is based on the statistical-data.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram of a fleet management system which employs a plurality of electronic control unit data recorders, each of which is in accordance with an embodiment of the present invention;

FIG. 2 provides a high level diagram of each of the electronic control unit data recorders shown in FIG. 1;

FIGS. 3-5 provide flowcharts regarding the automated configuration deployment, management, selection, error-handling and configuring of each of the electronic control unit data recorders shown in FIG. 1;

FIG. 6 provides a block diagram of the electronic control unit data recorder, as well as some external components of the overall system; and

FIG. 7 provides a table of sample electronic control unit data recorder diagnostic codes (V-Codes).

### DETAILED DESCRIPTION

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

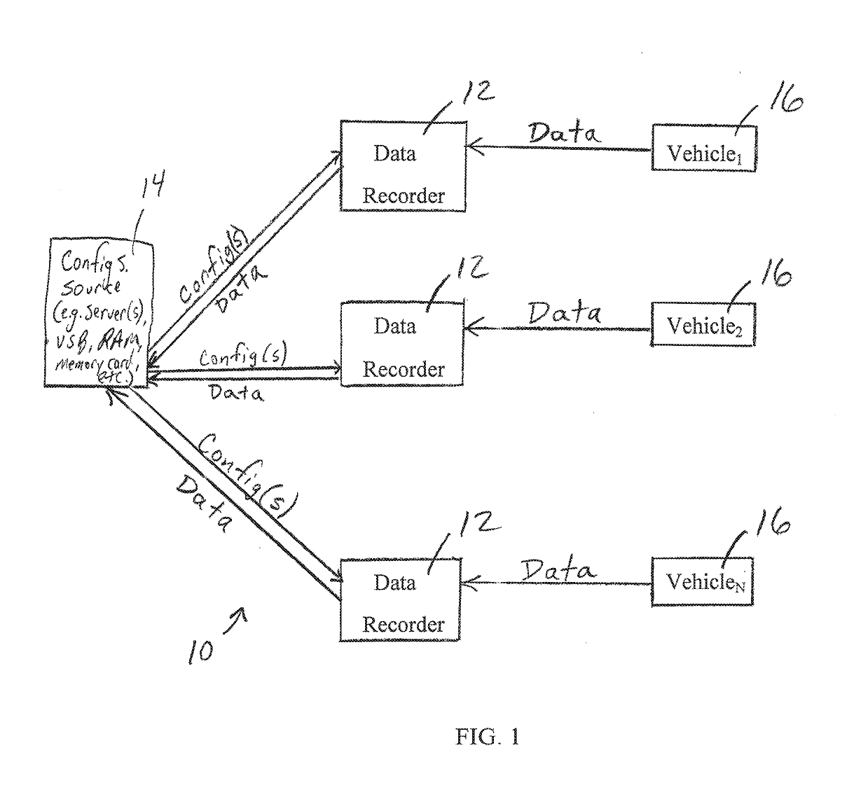

FIG. 1 illustrates a fleet management system 10 which employs a plurality of electronic control unit data recorders 12, hereafter the data-recorder 12, wherein each instance of the data-recorder 12 is identical and in accordance with an embodiment of the present invention. Each instance of the data-recorder 12 contains code in its memory which provides, as shown in FIG. 1, that the data-recorder 12 receives a plurality of configurations from one or more servers 14 and stores the configurations in memory. Each of the configurations which is received and stored in the memory of the data-recorder 12 relates to, for example, a different vehicle configuration, wherein the configuration is specific with regard to several factors, such as the make of the vehicle, the exact level of model year, as well as the exact engine, transmission, emission systems, and electronic control unit hardware/software, etc. embodied in the vehicle.

The code stored in the memory of the data-recorder 12 provides that thereafter the data-recorder 12 can be interfaced with a vehicle 16 (in FIG. 1, the vehicles 16 are identified with “Vehicle₁”, “Vehicle₂”, . . . “Vehicle_{N}”, thereby indicating that each of the vehicles can be of a different configuration (i.e., a different configuration with regard to the make of the vehicle, the exact level of model year, as well as the exact engine, transmission, emission systems, and electronic control unit hardware/software, etc. embodied in the vehicle), and the data-recorder 12 receives information from the vehicle 16 which allows the data-recorder 12 to identify the exact configuration of the vehicle 16. Based on the identification, the data-recorder 12 effectively selects one of the configurations stored in memory to use in connection with data collection and processing vis-à-vis the electronic control units of the vehicle 16. The data-recorder 12 may also store in memory a default configuration which can be used whenever the data-recorder 12 is unable to identify the exact configuration of a given vehicle.

Alternatively, the code stored in the memory of the data-recorder 12 can be configured such that the data-recorder 12 receives information from the vehicle 16 which allows the data-recorder 12 to identify the exact configuration of the vehicle 16 and then based on the identification, the data-recorder 12 retrieves the correct configuration from the one or more servers 14 and stores the configuration in memory for subsequent use in connection with data collection and processing vis-à-vis the electronic control units of the vehicle 16.

Still further, instead of having to obtain one or more configurations from a remote location such as from one or more servers 14, a plurality of configurations may be pre-stored in the memory of the data-recorder 12. As such, as shown in FIG. 1, reference numeral 14 can refer to any appropriate source for the configurations, such as one or more remote servers, a USB port on the data-recorder 12, RAM of the data-recorder 12, a memory card (such as an SD card) of the data-recorder 12, etc. Regardless, preferably thereafter the data-recorder 12 receives information from the vehicle 16 which allows the data-recorder 12 to identify the exact configuration of the vehicle 16. Based on the identification, the data-recorder 12 subsequently uses the correct configuration in connection with data collection and processing vis-à-vis the electronic control units of the vehicle 16.

Regardless, the code stored in the memory of the data-recorder 12 provides that once the data-recorder 12 selects a configuration, the data-recorder 12 thereafter collects data from various electronic control units and processes the data pursuant to the configuration. The configuration also dictates what data is stored by the data-recorder 12, as well as also possibly what data is transmitted by the data-recorder 12 to a remote location.

Preferably, the code stored in the memory of the data-recorder 12 provides that the electronic control unit data recorder can communicate with the server(s) 14 and dynamically update at least one of its stored configurations, thereby providing a data-recorder 12 having a dynamic configuration.

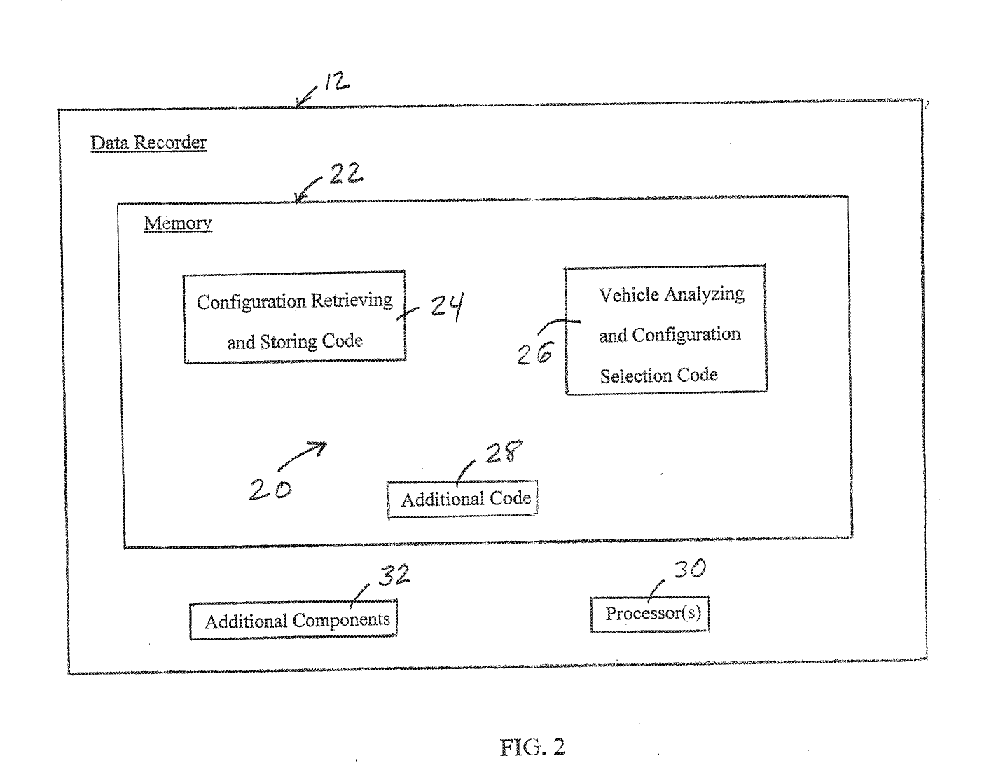

FIG. 2 provides a high level diagram of the data-recorder 12, including the code 20 which is stored in the memory 22 of the data-recorder 12, wherein the code is in accordance with a preferred embodiment of the present invention with other embodiments being entirely possible. As shown, a preferred embodiment of the present invention provides that the code 20 which is stored in memory 22 preferably includes configuration retrieving and storing code 24, which provides that the data-recorder 12 receives a plurality of configurations from one or more servers 14 (see FIG. 1) and stores the configurations in memory 22. As shown, the code 20 which is stored in memory 22 also preferably includes vehicle analyzing and configuration selection code 26, which provides that the data-recorder 12 receives information from a vehicle 16 (see FIG. 1) which allows the data-recorder 12 to identify the exact configuration of the vehicle 16. Thereafter, based on the identification, the data-recorder 12 effectively selects one of the configurations stored in memory 22 to use in connection with data collection and processing vis-à-vis the electronic control units of the vehicle 16. As shown, the code which is stored in memory also preferably includes additional code 28, including data acquisition code, which additionally dictates and controls the operation and functionality of the data-recorder 12. As shown in FIG. 2, in addition to the memory 22 and code 20 stored therein, the data-recorder 12 also includes one or more processors 30 as well as additional components 32 which are relevant to the operation and functionality of the data-recorder 12.

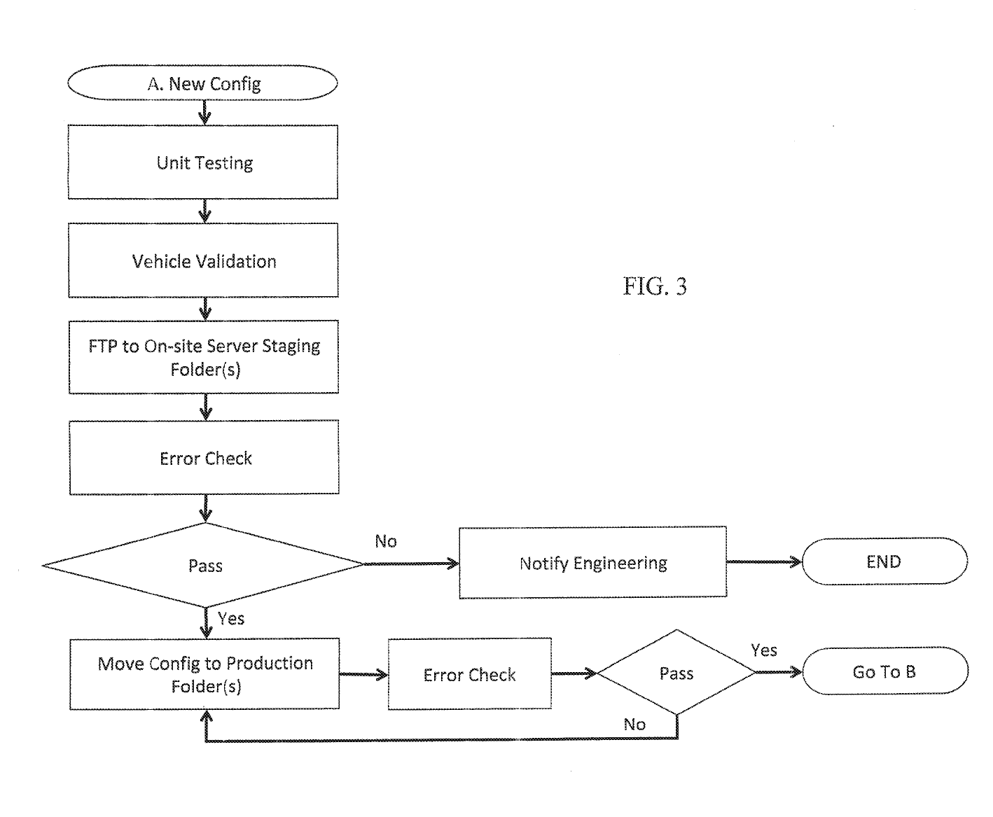

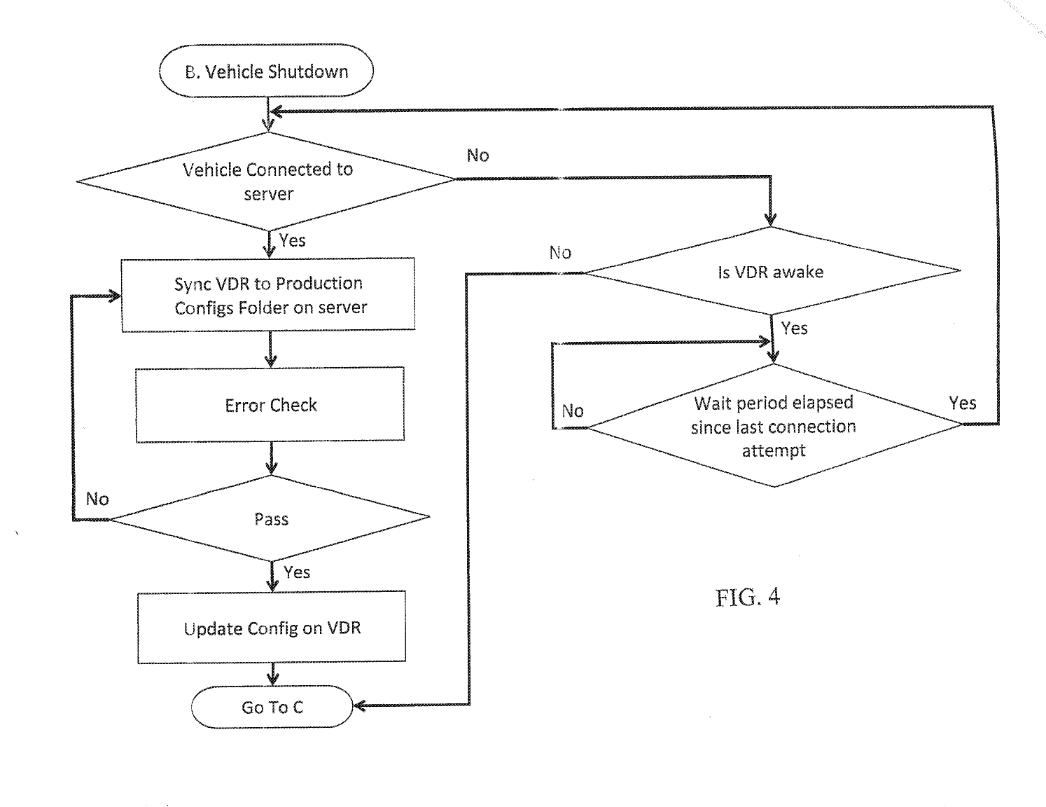

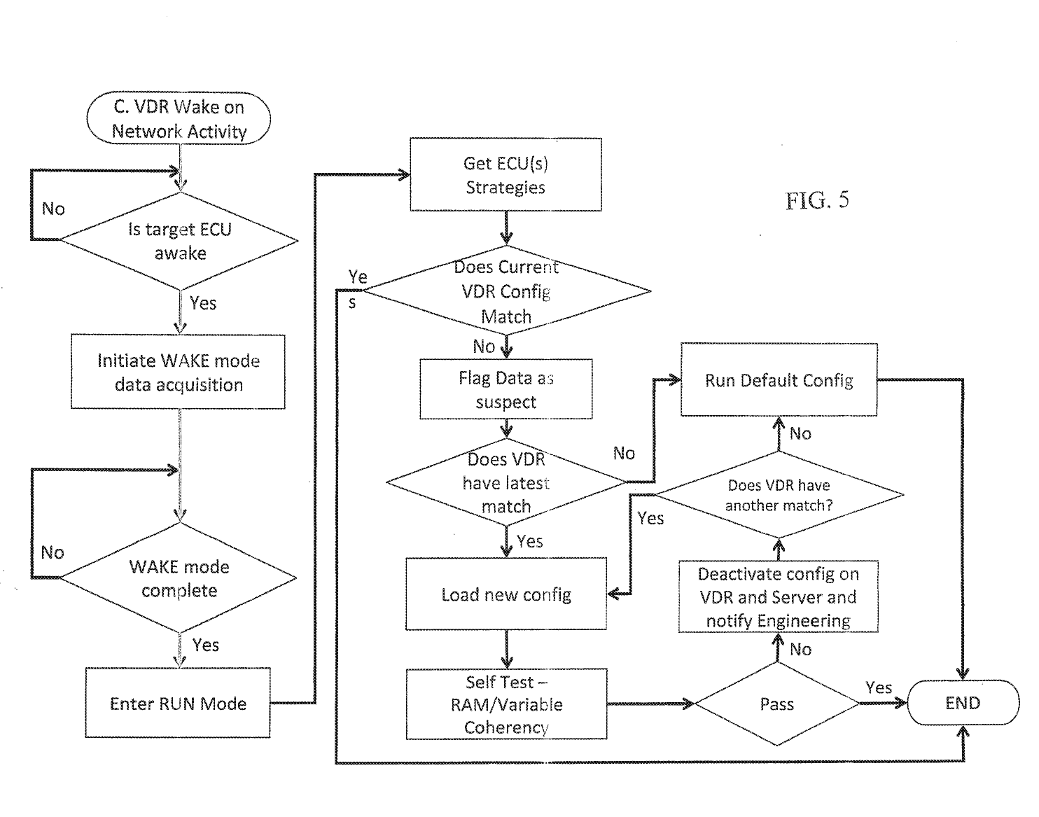

FIGS. 3-5 provide flowcharts regarding the automated configuration deployment, management, selection, error-handling and configuring of the data-recorder 12 (and each instance of the data-recorder 12 shown in FIG. 1), and are self-explanatory.

Preferably, the code 20 which is stored in the memory 22 of the data-recorder 12 is configured such that the data-recorder 12 robustly performs automated vehicle data acquisition and management. In contrast, conventional methods depend on the user to physically setup the system and then deploy it. This type of system is then not robust with regard to any changes that may occur in its test environment which would result in the acquisition of non-useable data.

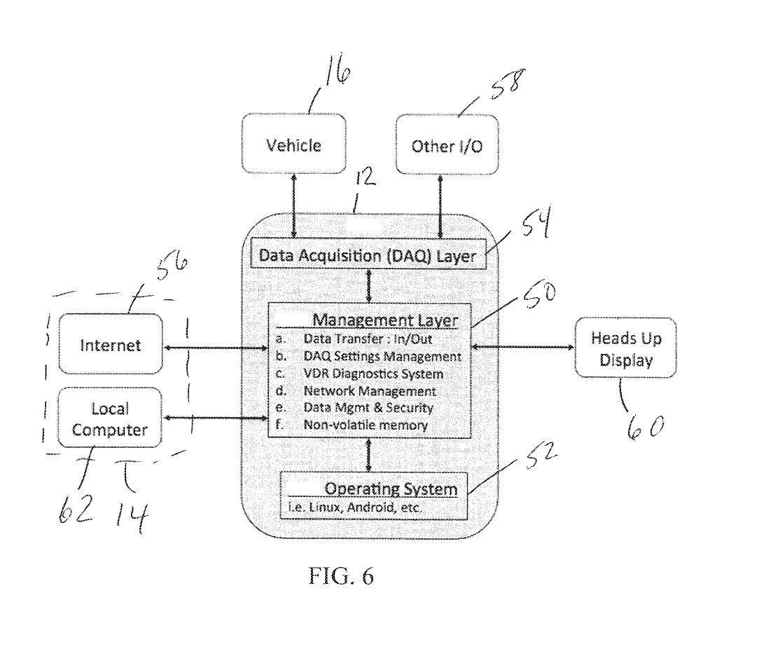

As described above, and as shown in FIG. 2 in addition to configuration retrieving and storing code 24 and vehicle analyzing and configuration selection code 26, the memory 22 of the data-recorder 12 contains additional code 28. Some of that additional code 28 is further described with reference to FIG. 6. This additional code provides that the data-recorder 12 is configured to acquire data, as well as contains code for data management, data transfer, data acquisition settings, a diagnostic system and preferably more. The additional code may include what may be called the “Management Layer” 50 which runs as a program stored in the memory of the data-recorder 12, and additional code which may be called the “Data Acquisition Layer” 54. Preferably, the Management Layer 50 is configured to have the flexibility to be uploaded remotely from the server 14 via an internet connection 56 either in a manual or automated fashion.

As shown in FIG. 6, the data-recorder 12 may also be in communication with other I/O 58, and may be connected to a heads up display or display device 60 as well as a local computer 62.

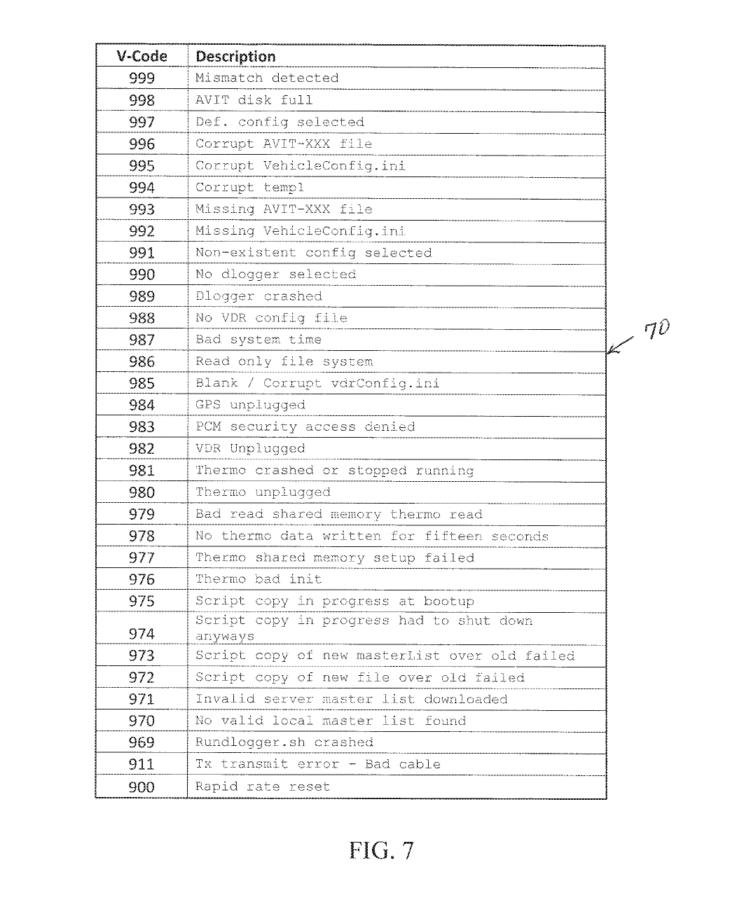

Regardless, preferably the Management Layer 50 includes code which is configured to provide the following:
a) data transfer in and out of the data-recorder 12, where the data can be data acquired and recorded by the data-recorder 12, diagnostic data relating to the data-recorder 12, Data Acquisition (DAQ) configuration files relating to the data-recorder 12, and/or management configuration files relating to the data-recorder 12;
b) a DAQ Settings Management function, where the data acquisition protocol, supported data and/or the corresponding DAQ configuration file is automatically determined;
c) that the diagnostics system of the data-recorder 12 monitors the performance of the data-recorder 12 to ensure that useful data is being recorded at all times. FIG. 7 provides a table 70 of sample electronic control unit data recorder diagnostic codes (V-Codes).
d) network management handles all connectivity to the data-recorder 12 via a local computer 62 or the internet 56. Preferably, this function can automatically select among available local, WiFi, and/or supported cellular networks. More specifically, preferably the data-recorder 12 is configured to logically decide whether to transmit data via WiFi, transmit data via a cellular network, or whether to store the data locally on local physical removable data storage, such as on a removable USB drive, in order to prevent the internal memory of the data-recorder 12 from becoming so full that the data-recorder 12 no longer acquires data. This function is also responsible for logical access control to different areas of the software system of the electronic control unit data recorder;
e) data management and security, which is responsible for all data storage and data security; and
f) that data is recorded on non-volatile memory, where that data is preferably stored in between power-on times of the electronic control unit data recorder, to enable proper function of the DAQ Layer 54 and Management Layer 50.

As discussed above, and as shown in FIG. 2 in addition to configuration retrieving and storing code 24 and vehicle analyzing and configuration selection code 26, the memory 22 of the data-recorder 12 contains additional code 28 relating to the acquisition of data, data management, data transfer, data acquisition settings, a diagnostic system and preferably more.

Preferably, the additional code 28 is configured such that the data-recorder 12 is capable of acquiring data simultaneously for many different use cases or modes. These consist of, but may not be limited to the following:
a) simultaneous high-speed data acquisition (i.e., faster than 1 Hz);
b) on-board synthetic-data parameters as a function of sampled-data;
c) high-speed data acquisition for a trigger, based on the sampled-data or synthetic-data, i.e., event-based high-speed trigger;
d) high-speed data acquisition for a trigger based on a time-interval, i.e., time-based high-speed trigger;
e) simultaneous low-speed data acquisition (i.e., slower than 1 Hz);
f) low-speed data acquisition while a condition is true based on the sampled-data or synthetic-data, i.e. low-speed event-based trigger;
g) low-speed data acquisition while a condition is true based on time, i.e., low-speed time based trigger;
h) Snapshot (i.e., one sample only) data acquisition based on an event of the sampled-data or synthetic-data, i.e., event-based snapshot;
i) Snapshot (i.e., one sample only) data acquisition based on time, i.e., time-based snapshot;
j) On-board statistical-data acquisition based on sampled-data or synthetic-data that provides event counts, histograms, minimum, maximum, average, standard deviation, variance, signal-to-noise ratio, frequency, and more;
k) dynamically change subsequently sampled-data or synthetic-data based on the currently sampled-data or synthetic-data or other input for a calibratable number of samples or time-interval;
l) real-time data broadcasted to user from vehicle through Qualifier system. User can change which parameters are broadcasted from the vehicle via the Qualifier website; and/or
m) all of the above modes are applied to all available electronic control units of the vehicle which are accessible by the data-recorder 12.

As suggested above, the additional code 28 may configure the system 10, or more specifically the data-recorder 12, to acquire or capture sampled-data in any combination of the above described use cases or modes a)-m). For example, the additional code 28 may operate aspects of the DAQ layer to configure data acquisition (DAQ) settings of the data-recorder 12 to employ a combination of modes c), d), f), and/or g) to capture data from the vehicle 18 at a first data-rate (e.g. low-speed data acquisition at 1 Hz) when a first trigger-signal transitions to a first state (e.g. key-on to key-off), and capture data from the vehicle at a second data-rate (e.g. high-speed data acquisition at 100 Hz) when a second trigger-signal transitions to a second state (key-off to key-on, or engine-off to engine-running).

By way of further example and not limitation, the system 10 may be configured to record only engine-coolant temperature at a relatively low sample-rate (e.g.—1 Hz, i.e. 1 second sample interval) until the status of the vehicle ignition-key transitions (e.g. key-off to key-on) and continue low frequency sampling of engine-coolant temperature while the system 10 simultaneously records at a relatively high sample-rate (e.g.—100 Hz, i.e. 10 ms sample interval) multiple relatively high-speed signals files and snapshots such as engine-air-flow-rate and/or fuel-injector duty-cycle, the sampling of which may be initiated based on unique trigger conditions. The system 10 may be further configured to record/sample additional signals for a prescribed time-interval after a particular trigger-event. Trigger-event examples include a high-speed data pre/post around a check-engine light coming on or the engine stalling, and snapshot examples would be a diagnostic test result or a transmission shift time after a transmission shift occurs.

In another embodiment, the additional code 28 may operate aspects of the DAQ layer to configure data acquisition (DAQ) settings of the data-recorder 12 to employ a combination of modes a) and e) to configure the data-recorder 12 to capture data simultaneously at the first data-rate and the second data-rate when the second trigger-signal transitions to the second state. For example, after the engine is started, engine coolant temperature may be recorded at 1 Hz, and engine intake airflow rate may be recorded at 100 Hz.

In another embodiment, the additional code 28 may operate aspects of the DAQ layer to configure data acquisition (DAQ) settings of the data-recorder 12 to employ a combination of modes b) and h) to configure the data-recorder 12 to process data to determine an on-board synthetic-data parameter based on sampled-data. Then instead of basing the first-trigger-signal on a directly monitored signal, the first trigger-signal may be based on the on-board synthetic-data parameter. For example, when a predetermined combination of throttle-position and engine-speed is detected, the first trigger-signal may be generated

In another embodiment, the additional code 28 may operate aspects of the DAQ layer to configure data acquisition (DAQ) settings of the data-recorder 12 to employ modes d) and/or k) to configure the data-recorder 12 to generate the second trigger-signal a time-interval after the first trigger-signal. For example, the system 10 may be configured to initiate the sampling or collecting of data in response to a key-on to key-off event, and continue to record signals from a predetermined list for a predetermined duration of time. This configuration may be useful evaporative emissions testing, for example.

In another embodiment, the additional code 28 may operate aspects of the DAQ layer to configure data acquisition (DAQ) settings of the data-recorder 12 to employ mode j) to configure the data-recorder 12 to determine statistical-data based on sampled-data, where the statistical-data may be characterized as one or more of of a minimum, a maximum, an average, a standard deviation, a variance, a signal-to-noise ratio, and a frequency, the first trigger-signal is based on the statistical-data, and the like.

By way of further example, the system 10 may be configured to initiate the sampling or collecting of data in response to a key-off to key-on event, continue to capture data while the engine is warming up, and stop recording once the engine reaches a predetermined or normal operating temperature.

By way of further example, the system 10 may be configured to calculate statistics during a drive-cycle and storing the statistics in memory. Then when the key is turned off, the statistics are recorded as a snapshot file. Example statistics would be maximum observed catalyst temperature, average vehicle speed, time at idle, etc.

While an electronic control unit vehicle recorder which is useable with a plurality of different types of vehicles has been described above, an electronic control unit vehicle recorder which is in accordance with an embodiment of the present invention may instead by configured for use with only one type of vehicle, but which is capable of acquiring or transmitting data in different modes.

Additionally, while the present disclosure specifically discusses a vehicle data recorder as being the type of electronic control unit data recorder with which the present invention is utilized, the present invention can be implemented in many other types of devices and systems. For example, the present invention can be used to manage a fleet of boats, a plurality of bridges, or really anything which is capable of being monitored and/or controlled by one or more electronic control units.

While a specific embodiment of the present invention is shown and described, it is envisioned that those skilled in the art may devise various modifications without departing from the spirit and scope of the present invention. While this invention has been described in terms of the preferred embodiments thereof, it is not intended to be so limited, but rather only to the extent set forth in the claims that follow.

We claim:

1. A system for recording data from one or more electronic control units in one or more vehicles, said system comprising:
a data-recorder suitable for communication with an electronic control unit of a vehicle;
a memory in communication with the data-recorder, said memory used to store configurations of vehicles, said configurations used to configure the data-recorder to communicate with the vehicle, said memory also used to store additional code used to configure data acquisition (DAQ) settings of the data-recorder to capture data from the vehicle at a first data-rate when a first trigger-signal transitions to a first state, and capture data from the vehicle at a second data-rate when a second trigger-signal transitions to a second state.

2. The system in accordance with claim 1, wherein the data-recorder captures data simultaneously at the first data-rate and the second data-rate when the second trigger-signal transitions to the second state.

3. The system in accordance with claim 1, wherein the data-recorder determines an on-board synthetic-data parameter based on sampled-data, and the first trigger-signal is based on the on-board synthetic-data parameter.

4. The system in accordance with claim 1, wherein the second trigger-signal occurs a time-interval after the first trigger-signal.

5. The system in accordance with claim 1, wherein the data-recorder determines statistical-data based on sampled-data, said statistical-data characterized as one of a minimum, a maximum, an average, a standard deviation, a variance, a signal-to-noise ratio, and a frequency, and the first trigger-signal is based on the statistical-data.
